(19) United States
(12) Patent Application Publication
(10) Pub. No.: US 2022/0386560 A1
(43) Pub. Date: Dec. 8, 2022

(54) APPARATUS FOR THE DISTRIBUTION OF ANIMAL BEDDING MATERIAL AND/OR FEEDSTUFF

(71) Applicant: STRAW SPREADER LTD, Lydney (GB)

(72) Inventor: Tom Robinson, Lydney (GB)

(21) Appl. No.: 17/755,806

(22) PCT Filed: Nov. 20, 2020
(86) PCT No.: PCT/GB2020/052969

§ 371 Date: May 9, 2022

(30) Foreign Application Priority Data
Nov. 20, 2019 (GB) 1916881.4

(51) Int. Cl. A01K 5/00; A01F 29/00

(52) U.S. Cl. CPC A01K 5/002; A01F 29/005

(57) ABSTRACT

The invention relates to apparatus for dispensing feed and/or bedding material for animals. The apparatus includes a body mounted on a base and the body includes a hopper for the said material and a rotor assembly to dispense the material from the hopper, said body movable with respect to the base and/or said rotor assembly movable with respect to the hopper to allow the condition of operation of the apparatus to be selected between a condition for best dispensing feed material and a condition for best dispensing bedding material. The apparatus is typically mounted on a transport vehicle. The selective movement of the body and/or rotor assembly, and typically other control functions can be controlled by a person operating control means which communicate with the apparatus via a wireless communication system and the apparatus can include a power supply to allow the same to be powered to operate independently of the transport vehicle and said power supply may be charged by operation of the rotor assembly.

The invention to which this application relates is apparatus for use in the spreading of a bedding material and/or feedstuff for animals and particularly, although not necessarily exclusively, to allow the spreading of the material to be achieved within a building or alternatively, in a field.

It is well-known that there is a need from time to time to be able to spread bedding material such as straw, or feeding material such as silage, onto or within a predefined area. Conventionally, this can either be achieved by manual movement of the material, which is time and labour consuming or alternatively, using apparatus, but it is found that the conventional apparatus tends to be designed for specific and exclusive purposes in terms of particular feedstuff types or bedding types and/or cannot be easily used in a specific environment such as in confined spaces or the like. This tends to mean that while there is a range of apparatus types available, a farm at which the apparatus could usefully be used, may be required to have a number of different forms of apparatus so as to suit particular different uses. This therefore means that, and especially for many smaller farms, the cost of purchasing the different versions of the apparatus, is prohibitive.

Furthermore, even when apparatus is used, the use of the apparatus can still be time-consuming in that the apparatus is required to be mounted on a transport vehicle such as a telehandler or tractor, and then electrically, mechanically and hydraulically coupled to the transport vehicle so as to provide power and hydraulics from the vehicle to the apparatus so as to be able to use the same. Furthermore, when one considers that the same transport vehicle may also be used to take the bale of material from a stack, and then place the same in the apparatus for use to spread the same, it will be appreciated that there is a need to couple and decouple the apparatus at frequent intervals which is time-consuming and frustrating for the user.

An aim of the present invention is therefore to provide apparatus of a form which can be used to perform the spreading of material, and which can be used independently, or at least semi independently from the transport vehicle and thereby reduce the coupling requirements between the apparatus and the transport vehicle.

In a first aspect of the invention, there is provided apparatus for the dispensing of bedding and/or feed material for use by animals and wherein the apparatus includes a hopper in which the said material is located and from which the material is moved by a rotor assembly to be dispensed into an area adjacent the apparatus and wherein the apparatus is operable in a first condition suitable for the spreading of feed material and at least a second condition suitable for the spreading of bedding material from the apparatus.

In one embodiment, the material used for bedding is obtained from a bale of straw located in said hopper and the material used for feeding is obtained from a bale of silage or hay located in said hopper. Ant ties or retaining means will be removed from the bale when positioned for dispensing material therefrom.

Typically the apparatus is capable of being provided in plurality of configurations which are selectable so as to enable the apparatus to be adaptable with regard to the original form in which the material is originally provided i.e. as a round bale or as a rectangular bale of the material.

Typically, in whichever condition, the spreading of the material from the apparatus is achieved via operation of a rotor assembly, provided at or towards one end of the hopper so as to engage with and remove material in a gradual manner from the adjacent face of a bale of the material and cause the material to be dispensed and spread from the apparatus hopper into the adjacent area.

Typically, the speed of rotation of the rotor, is selected so as to allow the dispensed material to be spread to a sufficient distance so as to clear the apparatus and land in or on the area in which the material is to be subsequently used.

Typically, the rotor assembly, when rotating, acts as a means of teasing the material from the bale rather than more aggressively removing the material from the bale and thereby minimise the creation of dust and the acceleration of stones or other materials which may be present in the bale and which would otherwise, if a more aggressive removal was used, cause damage to a building or risk of injury to animals or personnel.

In one embodiment, the rotor assembly includes a series of plates which are mounted at spaced intervals along a central shaft.

Typically, the plates are independently mounted on the shaft so as to allow the replacement of plates independently from the others and thereby avoid the need for a whole rotor to be dismantled should one or more plates be damaged.

In one embodiment, the arrangement of the plates with respect to the shaft and/or the direction of rotation of the shaft is reversible so as to allow the rotor to be operable in different modes to suit the particular use of the apparatus at that time.

In one embodiment, each plate includes a V-shaped portion and at least one of the surfaces of the plates may include one or more teeth formations therein.

In one embodiment, the rotor is driven, at one side, by a drive means, such as a motor and, at the opposing end, or at another location so as to be influenced by the rotation of the shaft, there is provided an alternator and charging system which allows a charge to be generated for one or more power cells.

In one embodiment the selection of the particular condition of the apparatus is achieved by the selective movement of the position of the rotor assembly with respect to the hopper and this adjustment allows the rotor assembly to be moved to an optimum position for movement of the material from the hopper and be dispensed.

Typically the power cells are located on the apparatus so as to provide a power supply to the apparatus which is available independently of any power supply which may be provided from the transport vehicle on which the apparatus is mounted for use.

Typically the said apparatus is operable and/or controllable independently of the transport vehicle. Thus the person operating the apparatus need not be present in the cabin of the vehicle when operating the apparatus.

In one embodiment, the power supply which is provided is a 24 Volt power supply.

In one embodiment, the control means for the apparatus includes a wireless communication means which is mounted on and/or connected with the apparatus and which, in one embodiment, is provided by power from the power cells on the apparatus.

In one embodiment, the wireless control system allows the control of any, or any combination, of the adjustment of the height of the rotor, the switching of the rotor on and off, the adjustment of the direction from which the material is spread from the apparatus, the speed of operation of the motor, and/or one or more warning systems provided for the operation of the apparatus.

Typically, wireless connection between the control system of the apparatus and a person within a cab of a transport vehicle and/or any person who is within range of the wireless communication system.

In on embodiment the wireless communication system can utilise, Wi-Fi®, Bluetooth® or any other suitable wireless communication system.

Typically, the apparatus includes a base including mounting means for use for the selective attachment of the apparatus with the transport vehicle and a body, said body including the hopper for receipt of the material which is to be spread therefrom, and the rotor assembly.

Typically the hopper is formed so as to encourage the movement of the material, such as one or more bales of the material, towards contact with the rotor assembly.

Typically the said body is selectively rotatable with respect to the base so as to allow the direction in which the material is to be spread from the hopper to be selected.

In one embodiment, this rotation of the body with respect to the base, is around a kingpin assembly which, typically, will include one or more cones, which can be selectively removed and replaced for maintenance purposes without the need to dismantle the rest of the kingpin assembly.

In one embodiment, the hopper includes a series of apertures therein which are located so as to allow the interior of the hopper and/or the material located therein to be viewed by the driver of the transport vehicle when the apparatus is mounted thereto.

In one embodiment, the control system includes the ability for a telemetry facility to be provided.

Typically, the hopper is provided of a size so as to receive therein, a round bale of the material without any significant alteration being required to the shape of the bale and can also receive a rectangular bale therein and in which case, the rectangular bale is bent so as to encourage the bale into contact with the rotor in order to allow material to be efficiently dispensed, and secondly to ensure that the bale can be accommodated within the hopper whilst maintaining the hopper and hence the apparatus overall of a relatively compact shape and size.

In a further aspect of the invention there is provided apparatus including dispensing apparatus for feed or bedding material for animals and a transport vehicle on which a base of the dispensing apparatus is mounted for use, a body mounted on the base which includes a hopper for the said material and a rotor assembly to dispense the material from the hopper, said body movable with respect to the base and/or said rotor assembly movable with respect to the hopper and wherein the selective movement of the body and/or rotor assembly is controlled by a person operating control means which communicate with the apparatus via a wireless communication system.

In one embodiment the dispensing apparatus has a power supply to allow the same to be powered to operate independently of the transport vehicle.

Specific embodiments of the invention are now described with reference to the accompanying drawings wherein:

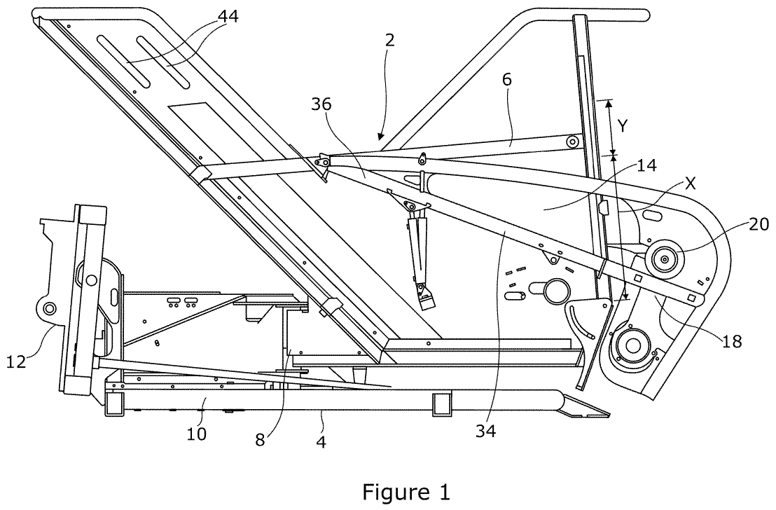

FIG. 1 illustrates a sideview of the apparatus in accordance with the invention;

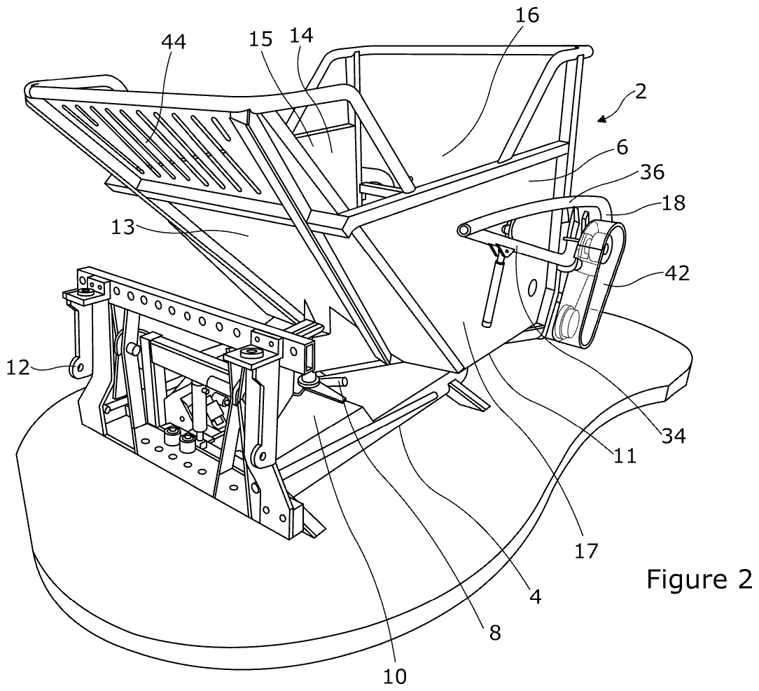

FIG. 2 illustrates a first end elevation of the apparatus in accordance with one embodiment of the invention;

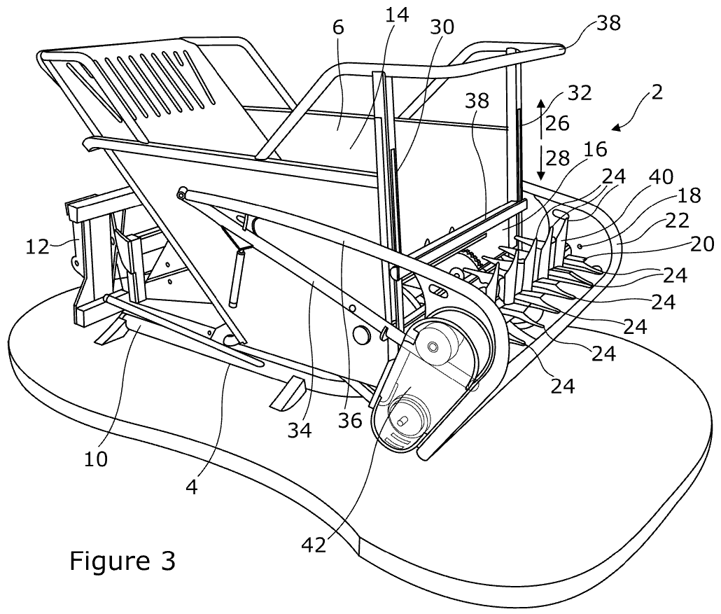

FIG. 3 illustrates the opposing end view of the apparatus in accordance with the invention;

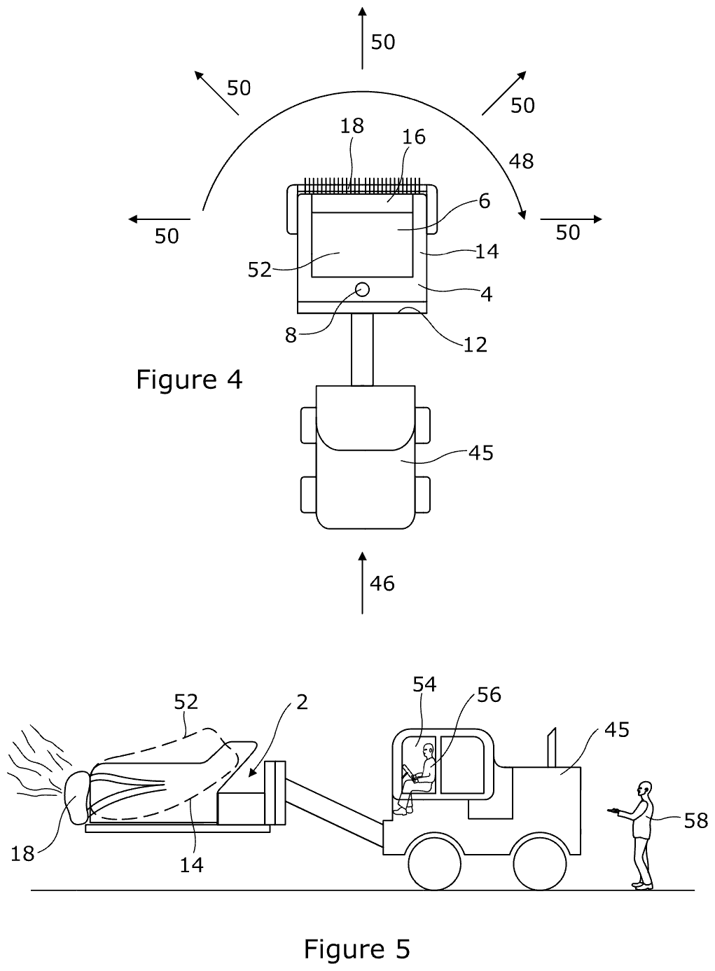

FIG. 4 illustrates the manner in which the body of the apparatus can be rotated with respect to the base; and

FIG. 5 illustrates the manner in which the apparatus can be controlled wirelessly.

Referring firstly to FIGS. 1-3, there is illustrated apparatus 2 in accordance with one embodiment of the invention, the apparatus including a base 4 on which is mounted a body 6 via a kingpin assembly 8 and about which the body can be rotated.

The base 4 includes a frame 10 which is typically formed of tubular metal so as to avoid or reduce the risk of any damage being caused to animals with which the same comes into contact, and, mounted on the frame, there are provided mounting means 12 which allow the apparatus to be mounted, typically, to the handling or front loading apparatus of a transport vehicle in a conventional mechanical manner. However, in accordance with the invention there is a reduced need for any electrical power coupling between the transport vehicle and the apparatus.

The body includes a hopper 14 which include a base 11 and side walls 15,17. At one end of the same and typically that which opposes the hopper wall 13 which acts as a guide means for bales of the material when introduced into the hopper, the hopper is provided with an open end 16 and a rotor assembly 18. The rotor is provided to rotate about longitudinal axis of the shaft 20 and has a number of plates 22 mounted at spaced intervals therealong. The shaft can be a square cross section shaft 20, and typically the plates are mounted independently so as to form, in combination, the rotor spikes 24 along the length of the shaft at spaced intervals along and around the shaft as shown for example in FIG. 3.

The location of the rotor 18 with respect to the hopper 14, is selectively adjustable adjusted as indicated by the arrows 26,28 by movement along guides 30,32 and adjustment of arms 34,36 on each side of the hopper 14, so that, in one embodiment of the apparatus the location of the rotor assembly 18 allows the condition of the apparatus to be selected to suit, in a first condition, the dispensing of bedding material and, in a second condition the dispensing of the feed material. Thus, for example, as shown in FIG. 1, movement of the rotor assembly so that the rotor shaft 20 is within the range X, allows the user to select the particular appropriate location for the rotor assembly with regard to the spreading of bedding material such as straw, and/or with regard to the particular bale type which is located in the hopper at that time, and when the rotor assembly 18 is moved so that the rotor shaft 20 is at a location within the range Y, which is above that of the range X, then the rotor assembly is best located for allowing the spreading of feed material located in the hopper. The particular type of feed material will be dependent upon the animal which are to be fed but may include vegetable, cereals, and/or fibrous feed such as hay. Once the location of the rotor has been selected for a particular use of the apparatus, then the hopper is locked in position for use. One or more barrier means 38 may also be provided which extend across the width of the opening into the hopper 14 so as to retain the bale in the required position.

The rotor assembly 18 is provided, at one end, with drive means 40 typically in the form of a drive chain which may be powered by hydraulics to rotate the rotor 18 at the required speed about the shaft. At the opposing end, there is provided a charging assembly 42 which includes an alternator and which provides a charging facility for one or more power cells which are located along with a wireless communication module and control means, typically on the frame 10 in a housing for protection on the apparatus and which therefore allow independent provision of power, preferably at 24 Volts, to allow the operation of functions of the apparatus and thereby potentially reduce or remove the need for electrical coupling with the transport vehicle for that purpose. The charging assembly charges the power cells when the rotor of the rotor assembly rotates. In one embodiment the communication, control and charging modules are mounted on the apparatus but can be selectively removed therefrom for use and/or maintenance.

Typically, as the rotor rotates, the spikes 24 ensure that the material in the hopper is moved outwardly from the hopper through the open end 16 and dispensed therefrom thereby spreading the material from the hopper and into the area of the field or barn adjacent to the apparatus.

The hopper 14 walls 13, 15, 17 can be provided with one or more viewing apertures 44 therein, so as to allow the interior of the hopper and the material therein to be viewed by the driver of the transport vehicle when the hopper 14 is mounted thereon

Referring now to FIG. 4, there is illustrated the manner in which the body 6 is rotatable with respect to the base 4 and mounting means 12 so as to allow the direction at which the material is spread from the apparatus to be selected. Thus, while it may be necessary for the transport vehicle 45 on which the apparatus is mounted, and the apparatus to be moved into a building in the direction of arrow 46 and in the particular orientation, it is then possible to adjust the position of the body 6 with respect to the base so as to allow dispensing of the material from a bale 52, in this case a round bale, located in the hopper 14 to be achieved in any selected position through 180° degrees as indicated by arrow 48 and arrows 50 illustrate examples of the directions in which the material may be dispensed and spread out from the open end 16 of the hopper by rotation of the rotor 18.

FIG. 5 illustrates the manner in which a person 56 can be located in the cab 54 of the transport vehicle 45 and use wireless control means to allow the control of the operation of the apparatus 2 via communication with the wireless control unit provided on the apparatus to allow the apparatus to be operated to spread material from the bale 52, in this case a rectangular bale, located in the hopper 14. Thus, no hardwiring is required between the transport vehicle 45 and the apparatus in order to allow the control of the apparatus to be achieved. This also means that a person 58 can operate the apparatus when they are not in the transport vehicle and standing within wireless range such as illustrated.

The current invention therefore provides a one person operable apparatus to reduce the laborious task of spreading large bales of straw or feed for livestock (cows, pigs, bulls, poultry and horses) from round or large square or rectangular bales.

Furthermore as the material is teased from the bales rather than chopped it tends to last longer, thereby providing savings in the use of the material. For example, savings of 30% of straw usage instead of manually rolling bales of straw out into the area, and savings of 10% in comparison to conventional chopping and blowing dispensing apparatus. The ability for the apparatus body to rotate and still spread through a range of 180 degrees, enables the apparatus to fit into the tightest of spaces in agricultural buildings and be used in any set-up, old fashioned buildings or large new ones. As the apparatus includes a wireless hydraulics control system and has a self-contained electrical system to support the charging of power cells this allows the wireless communication to be usable without requirement for any hard wiring to the transport vehicle. This in turn means that a detachable fork system used to load the bale from any location is less laborious in terms of connection coupling and decoupling.

Typically the rotor assembly height adjustment can be controlled from the cab for optimum material spreading and as the rotor is typically formed with plates formed from profiled steel sheet bolted to the central solid square shaft, this aids to reduce vibration and enable a customer to change an individual plate easily without high cost or down time. Typically the drive side of the rotor assembly includes a drive wheel with sprockets for connection with the motor to rotate the rotor and at the opposite side of the rotor 20, in the charging assembly 42 there is a pulley that drives the alternator and keeps the power cells charged. The operating voltage of the apparatus is preferably 24V and can be wholly or partially or selectively provided via the self-contained electrical system and power cells provided on the apparatus 2.

Typically the apparatus is provided with a hydraulic valve control which minimises the required flow of oil so is operable with most forms of transport vehicles hydraulic systems, old and new, and is also compatible with a tractor loader or telehandler. The optimum oil flow required is 45-50 litres of oil per minute, any more than that is simple returned back to the transport vehicle.

The apparatus is versatile and can be used on multi sites due to its integral control system being portable between apparatus and each control system can be programmed to be specific to a particular apparatus so as not to interfere with any other systems in the area. The communication system, if used therein can be plugged into the transport vehicle to gain power and support it working.

1. Apparatus for the dispensing of bedding and/or feed material for use by animals, said apparatus includes a hopper in which the said material is located and from which the material is moved by a rotor assembly to be dispensed into an area adjacent the apparatus, said apparatus is operable in a first condition suitable for the spreading of feed material and at least a second condition suitable for the spreading of bedding material from the apparatus, and wherein the apparatus is changed between the said first and second conditions by slidably moving the rotor assembly with respect to said hopper to a selected position within a range of possible positions.

2. Apparatus according to claim 1 wherein the material is provided as a bale from which the material is removed and dispensed by the rotor assembly.

3. (canceled)

4. Apparatus according to claim 1 wherein the rotor assembly is located at or towards one end of the hopper so as to engage with and tease material from the hopper and dispense the material from the apparatus.

5. Apparatus according to claim 1 wherein the speed of rotation of a rotor of the rotor assembly is adjustable to allow said material to be spread to a distance so as to clear the apparatus and land in or on the area in which the material is to be used.

6. Apparatus according to claim 1 wherein the rotor assembly includes a rotor formed by a series of plates which are mounted at spaced locations along a central shaft.

7. Apparatus according to claim 6 wherein the plates are independently mounted on the shaft so as to allow the replacement of plates independently from others.

8. Apparatus according to claim 5 wherein the arrangement of the plates with respect to the shaft and/or direction of the rotation of the shaft is reversable.

9. Apparatus according to claim 5 wherein each plate includes a V-shaped portion and at least one of the surfaces of the plate includes one or more teeth formations thereon.

10. Apparatus according to claim 1 wherein the rotor of the rotor assembly is driven to rotate at one side by a drive means and at the opposing side or at another location so as to be influenced by the rotation of the shaft there is provided a charging system which allows one or more power cells to be charged.

11. Apparatus according to claim 10 wherein the power cells are located on the apparatus to provide a power supply to the apparatus independently of any power supply which may be provided from a transport vehicle on which the apparatus is mounted.

12. Apparatus according to claim 1 wherein a control means for operation of the apparatus include a wireless communication system to allow the control of the apparatus using control means located on the apparatus or removed therefrom.

13. Apparatus according to claim 12 wherein the wireless communication system and control means allow the control of any, or any combination of the adjustment of the height of the rotor assembly, the switching of the rotor assembly on and off, the adjustment of the direction from which the material is spread from the apparatus, the speed of operation of the motor and/or one or more warning systems provided during operation of the apparatus.

14. Apparatus according to claim 12 wherein the wireless communication allows a person in a cab of a transport vehicle and/or any person who is within range of the communication system to control the apparatus.

15. Apparatus according to claim 1 wherein the apparatus is mounted on a transport vehicle when in use.

16. Apparatus according to claim 1 wherein the apparatus includes a base with which a mounting means for use for the selective attachment of the apparatus with a transport vehicle is provided, and a body, said body including the hopper and the rotor assembly.

17. Apparatus according to claim 1 wherein the hopper is formed so as to encourage the movement of the material therein towards contact with the rotor assembly.

18. Apparatus according to claim 16 wherein the said body is selectively rotatable with respect to the base so as to allow the direction in which the material to be spread from the apparatus is selected.

19. Apparatus according to claim 18 wherein the rotation of the body with respect to the base is around a kingpin assembly.

20. Apparatus according to claim 1 wherein the hopper for the bale includes a series of apertures therein which are located so as to allow the interior of the hopper and/or the material located therein to be viewed externally of the apparatus.

21. Apparatus including dispensing apparatus for feed or bedding material for animals and a transport vehicle on which a base of the dispensing apparatus is mounted for use, a body mounted on the base which includes a hopper for the said material and a rotor assembly to dispense the material from the hopper, said body movable with respect to the base and/or said rotor assembly movable with respect to the hopper and controlled by a person operating control means which communicate with the apparatus via a wireless communication system and wherein the movement of the rotor assembly with respect to the hopper is a sliding movement which allows the condition of the operation of the apparatus to be adjusted.

22. Apparatus according to claim 21 wherein the dispensing apparatus has a power supply to allow the same to be powered to operate independently of the transport vehicle.
